(19) United States
(12) Patent Application Publication
(10) Pub. No.: US 2003/0007001 A1
(43) Pub. Date: Jan. 9, 2003

(54) Automatic setting of video and audio settings for media output devices

(75) Inventor: John Zimmerman, Ossining, NY (US)

Correspondence Address: Corporate Patent Counsel, U.S. Philips Corporation, 580 White Plains Road, Tarrytown, NY, 10591, US

(73) Assignee: Philips Electronics North America Corporation

(21) Appl. No.: 09/876,529

(22) Filed: Jun. 7, 2001

(51) Int. Cl. H04N 5/44; G09G 5/00

(52) U.S. Cl. 345/716; 348/465

(57) ABSTRACT

Method and system for adjusting video and audio settings for a media output device. The system comprises a control unit having a media signal input. The media signal comprises at least one of a video and an audio component, as well as an associated informational component. The control unit extracts the informational component and adjusts at least one setting of the media output device based on the informational component.

### BACKGROUND OF THE INVENTION

1. Field of the Invention

The present invention relates generally to a system for automatically adjusting picture and sound settings of a video and/or audio output device, and more particularly to a system that receives a data stream associated with a program and uses the data stream content to adjust the picture and sound settings of the video and/or audio output device for the associated program.

2. Description of the Related Art

Currently there are systems providing information, in addition to video and audio signals, to a television, audio system, computer, or other output device. Systems for analog television services providing some sort of textual information are typically inserted in the vertical blanking interval lines of the normal television signal. This information may contain, for example, the closed captioning information, i.e. subtitling information, that is displayed on a display. Some services provide a more extensive description of the content of a television program. Newer developments of this analog technology send descriptors, relating to a television program on the same or separate channels, which is received by a set-top-box and displayed on a television screen. Similar systems are currently available in the field of digital program transmission.

In the digital arena, such informational data is streamed to a digital receiver. The stream can be a separate stream from the video and audio data, or multiplexed therewith. In either case the digital receiver receives the video, audio and informational data, processes each in separate processing paths, and outputs picture, sound and textual information from the television or other output device.

As with any advancing technology, the simple textual information has developed into what is now referred to as “metadata”. Metadata can generally be defined as control and descriptive elements associated to media content. The metadata is transmitted along with the media signal to an end user, for example, via radio waves, satellite signals, and/or via the Internet, and encompasses both analog and digital formats. Presently metadata is used to transmit electronic program guides (EPGs), which contain, among other items, a service description and event information descriptive of the video and audio content. This event information is frequently referred to as genre classifications or content type.

The metadata is generally proprietary information provided by a particular service or content provider. Some of the current content providers are DIRECTV™ (digital based system), GemStar™ (analog based system), and TiVo™ (Internet based system). Generally, each content provider transmits its metadata in a coded format. The existing technology allows a user to view the EPG information on the television display, but little else is being done with the information contained in the metadata stream.

As any television viewer knows, certain programs of a particular content type are better viewed at specific picture and sound settings. Content types are also known in the industry as genre classifications. A few of the available content types or genre classifications are sports, cartoons, music, science fiction, nature, and talk show. Content type information is transmitted as part of the metadata. FIG. 1 is a representative example of a metadata data string. For exemplary purposes the data string in FIG. 1 is shown in text format, but would be in a standard data format when actually transmitted. Shown in FIG. 1 are eleven elements, element a-element i. In this example, elements g and h are control elements and elements a-f and i-k are descriptive elements. Elements a-c, d-f and i-k are grouped into element blocks of three elements. Each element block contains descriptive elements associated with a particular program. In this example an element block contains descriptive elements describing channel, start time and content type. For example, element block a-c contains channel information, program start time, and content type, represented in element a, b, and c, respectively. Specifically, element block a-c reads as follows: on channel 40 (element a) starting at 12:30 PM (element b) is a sports program (element c). Similarly, element block d-f reads as follows: on channel 41 (element d) starting at 1:00 PM (element e) is a music show (element f). The present invention is primarily concerned with the content type element of each element block.

In the above example any number of additional elements may be provided in the metadata string to describe the program, and various different control signals can also be provided. Additionally, there are picture and sound settings that are best for different subcategories of the content types, e.g. different kinds of music. So in the above example instead of “music” contained in element f, element f might read “jazz”. The varying degrees of more and less specific descriptive content type elements are endless.

As a viewer switches from program to another, thus switching from one content type to another, the viewer must manually change the picture and sound settings for the best viewing experience. For certain settings, this manual change can often require several steps through a menu driven software program stored in the television or set top box.

### SUMMARY OF THE INVENTION

Thus, there exists a deficiency in today's technology to automatically adjust picture and sound settings based on the content type of a program. The present invention solves this deficiency.

It is, therefore, an aspect of the present invention to provide an apparatus and system for automatically adjusting sensory output settings of a sensory output device.

It is another aspect of the present invention to provide an apparatus and system for automatically adjusting the picture settings of a television or other display device.

It is yet another aspect of the present invention to provide an apparatus and system for automatically adjusting the sound settings of a television speaker or other audio output device.

Accordingly, the invention includes a method and system for adjusting video and audio settings for a media output device, such as a television, audio player and personal computer. The system comprises a control unit having a media signal input. The media signal comprises at least one of a video and an audio component, as well as an associated informational component. The control unit extracts the informational component and adjusts at least one setting of the media output device based on the informational component.

The method comprises receiving at least one of a video signal and an audio signal, as well as receiving an informational signal containing information descriptive of at least one of the at least one video signal and audio signal. At least one output setting of the media system is controlled based on the descriptive information of said informational signal.

### BRIEF DESCRIPTION OF THE DRAWINGS

The above and other objects, features and advantages of the present invention will become more apparent from the following detailed description when taken in conjunction with the accompanying drawings in which:

FIG. 1 is a diagram of an example of a metadata data string;

FIG. 2 is a block diagram depicting an embodiment of the present invention; and

FIG. 3 is a flow chart describing the operation of the preferred embodiment of the present invention.

### DETAILED DESCRIPTION OF THE PREFERRED EMBODIMENTS

Preferred embodiments of the present invention will be described herein below with reference to the accompanying drawings. In the following description, well-known functions or constructions are not described in detail since they would obscure the invention in unnecessary detail.

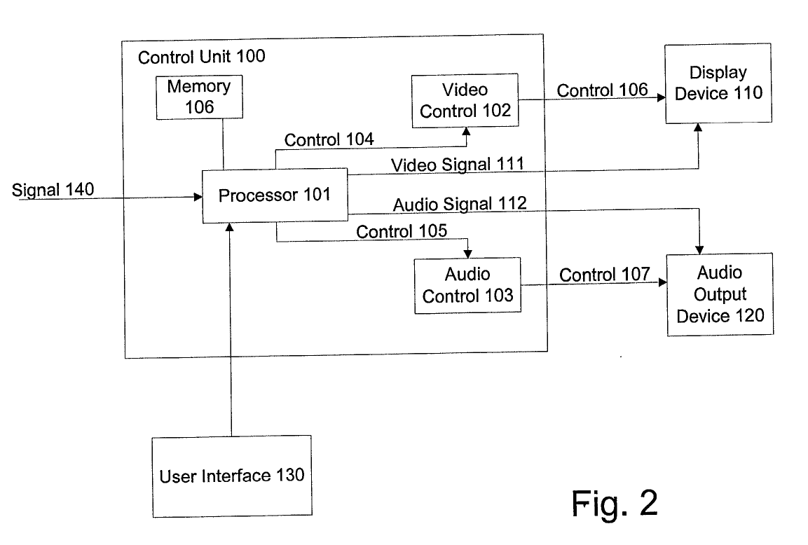

FIG. 2 is a block diagram depicting an embodiment of the present invention. Shown in FIG. 2 are control unit 100, display 110, audio output device 120, and user interface 130. Contained in control unit 100 are processor 101, video control 102, audio control 103, and memory 106. Processor 101 is programmed to receive an input signal and extract and identify the type of metadata content information contained therein.

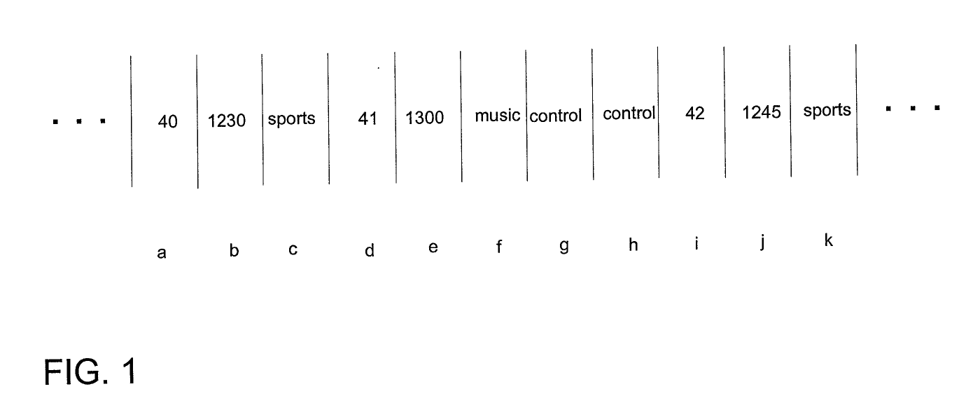

As was previously discussed, metadata is typically content provider specific. Though this is the current state of the technology, the present invention applies to both proprietary metadata and metadata that conforms to an industry standard. In the description of the present invention it will be understood that the metadata is received and if necessary the metadata will receive decoding, whereupon it will have a data string format as represented, for example, in FIG. 1. Thus, processor 101 receives signal input 140 comprised of video and audio data, as well as metadata. It is assumed that the metadata is decoded by processor, if necessary. Alternatively, the metadata may be decoded upstream, if necessary, and decoded data strings are included in signal input 140 to processor 101. Processor 101 or other device also extracts pertinent metadata from the metadata string, as described further below. For example, referring back to FIG. 1, if a television that receives the shown metadata string is tuned to channel 40, then processor 101 extracts elements a-c from the string for processing. Memory 106 stores data string tables associated with content type data strings of metadata of one or more content providers and/or standard metadata string format(s).

In the preferred embodiment, processor 101 also handles the video and audio signal processing. Processor 101 is connected to user interface 130. User interface 130 is for selecting and storing user-set picture and sound settings for the various content types. User interface 130 can be a remote control for the television, a computer keyboard, or other means for inputting user selections of content type, picture and sound settings. The system, for example through a menu driven programming mode, can facilitate the selection and storage of the user-set picture and sound settings in memory 106. Memory 106 is also used for storing data and programs to operate the system. As part of the overall setup of the content type picture and sound settings, the system can have stored in memory 106 preset default picture and sound settings for the convenience of the user and to be used in the event that no user settings have been programmed. Of course, in the preferred embodiment, a user could be given the option to turn on or off the automatic picture and sound feature. Table 1 shows one representative example of stored picture and sound settings in memory 106. The content types contained in Table 1 correspond to content types contained in the metadata elements. For example as shown in FIG. 1, elements c, f, and k of metadata string are sports, music, and sports, respectively. These two content types correspond to two “Content Type” headings in memory 106, as shown in Table 1.

TABLE 1

| | | | Content Type | | | |
|---|---|---|---|---|---|---|
| | | | | | | Talk |
| | | | Sports | Music | Sci-Fi | show |
| Picture Settings | Color | Pre-set | 4 | 5 | 7 | 5 |
| | | User-set | 6 | — | 6 | 4 |
| | Tint | Pre-set | 5 | 5 | 5 | 5 |
| | | User-set | 4 | — | — | 4 |
| | Bright- | Pre-set | 7 | 4 | 4 | 5 |
| | ness | User-set | 6 | — | 4 | — |
| | Contrast | Pre-set | 5 | 5 | 7 | 5 |
| | | User-set | 4 | — | 6 | 4 |
| Sound Settings | Volume | Pre-set | 5 | 7 | 8 | 5 |
| | | User-set | 4 | 9 | 6 | — |
| | Bass | Pre-set | 6 | 7 | 8 | 5 |
| | | User-set | 3 | 9 | 7 | — |
| | Treble | Pre-set | 5 | 5 | 8 | 5 |
| | | User-set | 4 | 9 | — | — |

Shown in Table 1 are four Content Type headings used to organize settings in memory 106 and which correspond to content data that may be contained in metadata of a received program. The four types are examples only as the actual metadata may contain many more classifications of content type. The content types shown are “sports”, “music”, “sci-fi”, and “talk show”, represented as column headings in the memory arrangement. Associated with each of the content types are exemplary picture and sound settings. Each of the picture and sound settings contain subclasses of specific picture and sound settings, namely, color, tint, brightness, contrast, volume, bass, and treble. Each of the specific picture and sound setting subclasses further contain a subclass that are default settings (“pre-set”) and settings set by the user (“user-set”). The pre-set settings are the default setting discussed above to be used in the absence of any user-set settings. The user-set settings are the values that are selected and entered in the memory by the user for the content type and the subclasses of picture and sound settings shown, as further described below. Each of the different picture and sound attributes for each content type in memory 106 are available for adjustment via the user-set input. Again, the attributes shown are for exemplary purposes only as there can be additional and different attributes depending on the particular output device. Shown in this example are picture subclasses “color”, “tint”, “brightness”, and “contrast”. Table 1 also shows that memory arrangement contains similar exemplary sound subclasses, including “volume”, “bass”, and “treble”. These attributes are not meant to be inclusive as different audio output devices can comprise different attributes. Also, the memory arrangement or records may include classifications pertaining to additional or different sensory output devices, for example, a surround sound system. In the surround sound system the memory of the present invention would contain particular memory areas for the settings of the surround sound system.

Returning again to Table 1, the actual settings stored in memory and shown in the table are represented by a scale of 1 to 10, 1 being the lowest setting and 10 being the highest. With respect to content type “sports” a pre-set color setting of 4 is stored in memory, and a user-set color setting of 6 has been saved in its memory area. In the preferred embodiment of the present invention, a user-set setting preempts a pre-set setting. Therefore, referring back momentarily to FIG. 1, when the system is tuned, for example, to channel 40, processor 101 will extract elements a-c from the metadata string in signal 140. Processor 101 thus determines from element c that the content type of channel 40 is “sports”. Processor 101 then searches memory 106, determines that, for “Sports” content type, there is a pre-set and user-set setting for color and uses the user-set setting and adjust the color output to 6. As described further below, the setting is used by the processor 101 to adjust the color output of display device 110 to setting 6 for the received sports show. In like manner, processor 101 retrieves the other “Sport” settings shown in Table 1, namely, tint setting of 4, brightness setting of 6 and contrast setting of 4 and adjusts the display device 110, as described below. In like manner, processor 101 retrieves the user-set sound settings from memory 106 and sets the sound settings to a volume of 4, a bass of 3 and a treble of 4 for the sports show.

As the user changes the channel, for example, to a science fiction program, processor 101 reads the science fiction content from the metadata and retrieves the user-set settings for Sci-Fi shown in Table 1 from memory 106. Thus, color is set to 6, brightness is set to 4, contrast is set to 6, volume is set to 6, and bass is set to 7. Since there are no user-set settings stored in memory 106 for “tint” and “treble” for the science fiction content (as designated by entry “-” in Table 1), the system sets the tint to pre-set value of 5 and treble to the pre-set value of 8.

Referring again to FIG. 2, processor 101 is also connected to video control 102 and audio control 103, through control lines 104 and 105, respectively. Control lines 106 and 107 are used to send the user-set or pre-set picture and sound settings retrieved from memory 106 by processor 101 to display device 110 and audio output device 120, respectively. Thus, in the above example of viewing a sci-fi program, among other settings, a tint setting of 5 is sent along control line 104 to video control 102. The tint setting of 5 is converted in video control 102 to a signal compatible with display device 110 and sent to display device 110 along control line 106. Also shown are video signal line 111 and audio signal line 112 for carrying video and audio signals from processor 101 to display device 110 and audio output device 120. For all such user-set or pre-set settings for the display device 110 and audio device 120 sent by processor 101, video control 102 and audio control 103 adjust the picture and sound settings to appropriate corresponding controls compatible with display device 110 and audio output device 120. It needs to be noted that control 104, video control 102, control 105 and audio control 103 could all be contained in processor 101, but are shown here as separate elements for more clarity of the present invention. In other variations of the present invention the metadata can be sent directly to display device 110 and audio output device 120. Display device 110 and audio output device 120 would contain processing capability and memory (analogous to memory 106) to store the conversion tables and to store the picture and sound settings, thereby consolidating processor 101, video control 102 and audio control 103 into display device 110 and audio device 120. Of course, display device 110 and audio device 120 may be a single unit, such as a TV. Control unit 101 may also be part of the TV.

Various display devices and audio output devices exist. An analog television, a digital television, a computer monitor are examples of display devices. A television speaker, a stereo, a surround sound system, computer speakers are examples of audio output devices. (Thus, as noted, display device 110 and audio output device 120 as shown in FIG. 1 are often found in a comprehensive audio-visual device.) Each of these devices, depending on the manufacture and model, will have varying control codes for controlling the picture and sound settings. By storing a simple code conversion table in memory 106, the present invention can be user set to interact with any manufacturer's device. Again, as this aspect of the invention is not central to the actual operation, the details will not be described herein. Also, the actual connection that control 106 and. control 107 represent may be a USB (universal serial bus) connection, a standard serial connector, a Bluetooth™ wireless system connection, or even the Internet. The processing provided by control unit 100 may thus take place at a remote site, with the manufacture and model specific codes transferred at the local output device.

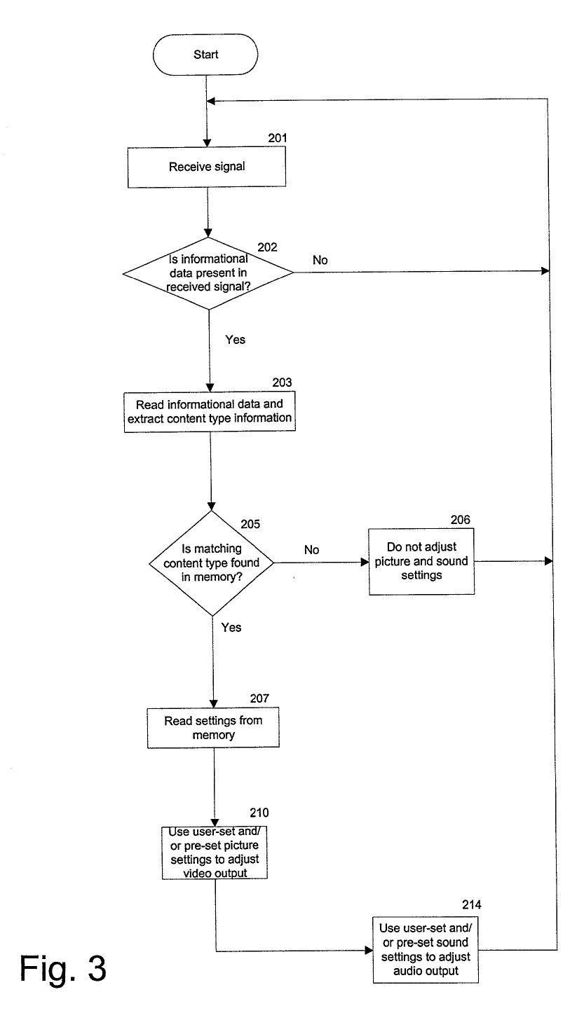

The operation of the preferred embodiment of the present invention will now be described with respect to FIG. 2 and FIG. 3. FIG. 3 is a flow chart describing the operation of the preferred embodiment of the present invention. In step 201 signal 140 is received by control unit 101. In step 202 processor 101 determines if the informational metadata is present in the received signal. If not, the process returns to step 201. If the metadata is present in the received signal, the process continues to step 203 wherein processor 101 reads the metadata and extracts the content type information for the user's selection (such as a channel) from the data string, as described above. In step 205 processor 101 determines if a matching content type is found in memory 106. If no match is found, no adjustments to the sound and picture are made in step 206, and the procedure returns to step 201. As can be seen, the process returns to step 201 to continually or periodically receive and process the metadata signal.

If, in step 205, a matching content type is found in memory 106, the processor 101 in step 207 reads the picture and audio settings from each subclass (i.e., color, tint, brightness, contrast, volume, treble, bass) from memory 106. During this step, both the pre-set and user-set settings may be read from memory 106. For any subclass of setting for a content type, however, a pre-set value is only used if there is no user-set setting in memory 106. Next, in step 210, processor 101 sends via control line 104 the user-set and/or pre-set picture settings (for color, tint, brightness, contrast and any other such settings) to video control 102, which in turn adjusts the picture settings of display device 110 via control line 106. In step 214 processor 101 sends via control line 105 the user-set and/or pre-set sound settings (for volume, bass, treble, etc.) to audio control 103, which in turn adjusts the sound settings of audio output device 120 via control line 107. Steps 210 and 214 may be reversed or integrated. The system returns to step 201 to continue the process indefinitely.

In a further embodiment of the present invention, the metadata itself could contain the picture and sound settings. Thus, the content provider can supply pre-set picture and sound settings to the user, wherein all that would be needed at the user's end would be an interface to convert the pre-set settings to control signals to be used by the user's output devices.

In a further embodiment of the present invention that utilizes the Internet to access the metadata, for example the TiVo™ system, an additional clock and tuner would be required in the present invention to properly synchronize the information. The TiVO™ type metadata supplies channel, time and content information. Thus the present invention, by reading the channel information from the tuner and the time from the clock can properly utilize the metadata.

The present invention has primarily been described by way of example as a device with video and audio outputs. Although this is a preferred embodiment, a device with only video or audio is also contemplated. One example of the audio output device are the common digital audio players (DAPs). These devices are so designed to playback digital audio files stored in its memory. Currently the digital audio file provided to the DAPs contain metadata as well as the digital audio data. By including the present invention in the DAP, the user of the DAP is provided with automatically adjusting sound settings as described previously herein with reference to the preferred embodiment.

It is also contemplated that variations to the metadata format and content are anticipated. To this extent, the metadata might contain additional features that today's user equipment does not even contain, for example, three dimensional settings, or various forms of interactive programming. Also as discussed previously, the content types can be as general or as detailed as needed. For example, instead of content type “sports” the content types could contain “baseball”, “football” and “soccer”. It is also contemplated that any type of sensory output device could be connectable to the present invention. For example, a scent generator could be connected to produce a hotdog smell during a baseball game. As can be seen great variations can fall within the confines of the present invention.

While the invention has been shown and described with reference to certain preferred embodiments thereof, it will be understood by those skilled in the art that various changes in form and detail may be made therein without departing from the spirit and scope of the invention as defined by the appended claims.

What is claimed is:

1. A system for adjusting video and audio settings for a media output device, comprising a control unit having a media signal input, said media signal comprising at least one of a video and an audio component, as well as an associated informational component, the control unit extracting said informational component and adjusting at least one setting of the media output device based thereon.

2. The system of claim 1, wherein said informational component contains data descriptive of the content of at least one of the video and audio components.

3. The system of claim 1, further comprising a user interface connected to said control unit that provides input of at least one user defined setting of the media output device corresponding to one or more content types, and a memory that stores said user defined settings associated with said content types.

4. The system as in claim 3, wherein the informational component extracted by the control unit from the media signal input is used to determine a corresponding content type in the memory and the at least one user defined setting associated with the corresponding content type.

5. The system as in claim 4, wherein the at least one user defined setting associated with the corresponding content type is used to adjust the at least one setting of the media output device.

6. The system as in claim 5, wherein the at least one setting of the media output device and the at least one user defined setting are at least one of a video setting and an audio setting.

7. The system as in claim 1, wherein the media output device is a television.

8. The system as in claim 1, wherein the informational component of the media signal comprises metadata.

9. A method for controlling output settings of a media system, comprising the steps of:
a) receiving at least one of a video signal and an audio signal;
b) receiving an informational signal containing information descriptive of at least one of the at least one video signal and audio signal; and
c) controlling at least one output setting of the media system based on said descriptive information of said informational signal.

10. The method of claim 9, wherein the step of controlling at least one of said output settings based on said informational signal includes retrieving at least one user setting selected from a group of video and audio settings, retrieval of the at least one user setting based on said informational signal.

11. The method as in claim 10, wherein the at least one user setting is used to control at least one of a video and audio output setting of the media system.

12. The method as in claim 10, wherein the informational signal comprises a content type of at least one of the video and audio signal, the retrieval of the at least one user setting based on said content type.
